(19) United States
(12) Patent Application Publication
(10) Pub. No.: US 2014/0344095 A1
(43) Pub. Date: Nov. 20, 2014

(54) METHOD AND SERVER FOR PROVIDING AUCTIONING GUIDE SEARCH

(71) Applicant: Intellectual Discovery Co., Ltd., Seoul (KR)

(72) Inventor: Hyun Cho Jung, Seoul (KR)

(73) Assignee: Intellectual Discovery Co., Ltd., Seoul (KR)

(21) Appl. No.: 14/368,928

(22) PCT Filed: Nov. 27, 2012
(86) PCT No.: PCT/KR2012/010094

§ 371 Date: Jun. 26, 2014

(30) Foreign Application Priority Data
Dec. 28, 2011 (KR) 10-2011-0145301

(51) Int. Cl. G06Q 30/08; G06Q 30/06

(52) U.S. Cl. CPC G06Q 30/08; G06Q 30/0625
USPC 705/26.3

(57) ABSTRACT

A method for providing auctioning guide search, according to one embodiment of the present invention, comprises: an auction guide search provision server outputting to an auction bidding user terminal a keyword input interface, which is an interface enabled with keyword input for searching an auction item, when an auction registered user terminal receives a request input for searching a registered auction item from a connected auction bidding user terminal; determining whether the number of auction items searched through an inputted auction item search keyword exceeds a predetermined number, when the inputted auction item search keyword to be searched is received from the auction bidding user terminal; outputting to the auction bidding user terminal at least one auction item from results that exceed the predetermined number so that a user can select a desired auction item from the number of auction items that exceed the predetermined number, when the number of auction items searched exceeds the predetermined number; and outputting to the auction bidding user terminal bidding information input interface, which is an interface for receiving inputted bidding information with respect to an auction item selected in accordance with an item selection input, which is received from the auction bidding user terminal.

### TECHNICAL FIELD

The present invention relates to a technique for providing a search for an item that can be sold or bought on a game by users.

### BACKGROUND ART

With the development of communications networks, various online game services have been being provided. Further, as graphics techniques and the performance of user terminals are improved, high-quality game programs are being created. Game contents which provide detailed descriptions for real or visual space have also been being developed.

Accordingly, the user utilization of online games is increased, and the game genres are diversified. Recently, various online games such as sports games, role playing games, and first person shooting games have been most popular.

As one feature of the online games, users can enjoy their favorite online games with each other by simultaneously accessing the same game contents system. The users can individually enjoy the games through cooperation or competition with different users by controlling its character or the like on the same game screen.

Moreover, in the online games, the users can accomplish one mission by cooperation with different users, or can enjoy game contents by competition with different users. In this case, in the online games, it is necessary to provide contents that rouse competitive spirit between the users. This is because it is required to have the users continuously access and play the online games by rousing the competitive spirit between the users in order to maintain or increase the user utilization of the online games in terms of their features.

The contents for rousing the competitive spirit between the users may be roughly divided into a level of a user character, an item that can be applied to the user character, a skill implemented by a user, and the like. Particularly, the level and the skill of the user character may be improved by the user while the user plays the game and increases an experience level of the user character.

Accordingly, a beginner should use items for improving the ability of his/her character to equally compete with skilled users having the higher experience level in the online games. As a result, services such as item design, item image, item sales, and the like have recently become hot issues in the online games.

Herein, auctioning may be used for selling items. The auction in the online games may enable a first user to register his/her auction items to an auction server by setting name, price, sale period, and the like of the auction items, and then a second user who desires to buy a desire auction item through the auction to search for the auction items and input an auction price for the desired auction item to thereby buy the auction item through successfully bidding for it.

However, in the case of a conventional method for buying items through the auction, there is a problem in having too many results which may causes overload of an auction server when a search keyword is not provided in detail.

In addition, when too many results are searched, it is required to input another keyword again to search desired items.

### DISCLOSURE

### Technical Problem

The present invention has been made in an effort to provide a method for providing an auctioning guide search having advantages of being capable of searching auction items simply and conveniently in a search for buying auction items through an auction in an online game.

### Technical Solution

An exemplary embodiment of the present invention provides a method for providing an auctioning guide search, including: by a server for providing the auctioning guide search, receiving a request input for searching an auction item registered by an auction-registering user terminal from an accessed auction-bidding user terminal and outputting a keyword input interface to the auction-bidding user terminal, the keyword input interface serving to facilitate an input for a keyword to search for the auction item; receiving an input of a keyword for searching a desired auction item to be searched from the auction-bidding user terminal and determining whether the number of auction items searched through the inputted keyword exceeds a predetermined reference value; when the number of the searched auction items exceeds the reference level, outputting at least one auction item searched to exceed the reference level to the auction-bidding user terminal to enable a user to select a desired auction item from among the excessively searched auction items; and outputting a bit information input interface to the auction-bidding user terminal, the bit information input interface serving to receive bit information related to auction items selected according to a selection input for the auction items received from the auction-bidding user terminal.

The outputting of at least one auction item searched to exceed the reference level to the auction-bidding user terminal may include outputting a selected item searching menu to the auction-bidding user terminal, the selected item searching menu serving to re-search for the auction items selected from among the auction items searched to exceed the reference value, or outputting a filtering selecting menu to the auction-bidding user terminal, the filtering selecting menu serving to facilitate an input for filtering the searched auction items per kind.

The method may further include, when the number of the searched auction items does not exceed the reference level, outputting a bid information input interface to the auction-bidding user terminal, the bid information input interface serving to receive bit information related to the searched auction items.

The outputting of at least one auction item searched to exceed the reference level to the auction-bidding user terminal may include, when a selection input of a user terminal related to a selected item search menu serving to facilitate selection from among the searched auction items through a right click of an indicator of the user terminal is received, outputting a result of searching an auction item that is subjected to the right click of the indicator to the auction-bidding user terminal.

The outputting of at least one auction item searched to exceed the reference level to the auction-bidding user terminal may include outputting a check box menu to the auction-bidding user terminal, the check box menu serving to facilitate a selection input for the auction items searched to exceed the reference value by a user.

The outputting of at least one auction item searched to exceed the reference level to the auction-bidding user terminal may include, when the number of the searched auction items exceeds the predetermined reference value, outputting information for reporting that the number of the searched auction items exceeds the reference value to the auction-bidding user terminal.

An exemplary embodiment of the present invention provides a server for providing an auctioning guide search, including: a keyword input section configured to receive a request input for searching an auction item registered by an auction-registering user terminal from an accessed auction-bidding user terminal and output a keyword input interface to the auction-bidding user terminal, the keyword input interface serving to facilitate an input for a keyword to search for the auction item; a multiple detection information determiner configured to receive an input of a keyword for searching a desired auction item to be searched from the auction-bidding user terminal and determine whether the number of auction items searched through the inputted keyword exceeds a predetermined reference value; , when the number of the searched auction items exceeds the reference level, a multiple detection information provider configured to output at least one auction item searched to exceed the reference level to the auction-bidding user terminal to enable a user to select a desired auction item from among the excessively searched auction items; and an auction item bidder configured to output a bit information input interface to the auction-bidding user terminal, the bit information input interface serving to receive bit information related to auction items selected according to a selection input for the auction items received from the auction-bidding user terminal.

The multiple detection information provider may output a filtering selecting menu to the auction-bidding user terminal, the filtering selecting menu serving to facilitate an input for filtering the searched auction items per kind.

The multiple detection information provider may output a check box menu to the auction-bidding user terminal, the check box menu serving to facilitate a selection input for the auction items searched to exceed the reference value by a user.

When the number of the searched auction items does not exceed the reference level, the auction item bidder may output a bid information input interface to the auction-bidding user terminal, the bid information input interface serving to receive bit information related to the searched auction items.

The multiple detection information provider may output a selected item searching menu to the auction-bidding user terminal, the selected item searching menu serving to re-search for the auction items selected from among the auction items searched to exceed the reference value.

When a selection input of a user terminal related to a selected item search menu serving to facilitate selection from among the searched auction items through a right click of an indicator of the user terminal is received, the multiple detection information provider may output a result of searching an auction item that is subjected to the right click of the indicator to the auction-bidding user terminal.

### Advantageous Effects

In accordance with the exemplary embodiments of the present invention, it is possible to obtain an outstanding effect of enabling a user to search and buy his/her desired auction items by providing a method for providing an auctioning guide search, for searching auction items simply and conveniently in a search for buying auction items through an auction in an online game.

### DESCRIPTION OF THE DRAWINGS

FIG. 1 is a flowchart showing a method for providing an auctioning guide search in accordance with an exemplary embodiment of the present invention.

FIG. 2 is a functional block diagram showing a server for providing an auctioning guide search in accordance with the present exemplary embodiment.

FIG. 3 shows an auction interface screen outputted to a user terminal according to FIG. 1 and FIG. 2.

FIG. 4 shows a check box menu for selecting at least one auction item information by a user on the auction interface screen outputted to the user terminal according to FIG. 1 and FIG. 2.

FIG. 5 shows the auction interface screen outputted to the user terminal according to FIG. 1 and FIG. 2, after an auction item is selected.

### MODE FOR INVENTION

Hereinafter, a method and a server for providing an auctioning guide search in accordance with an exemplary embodiment of the present invention will be described with reference to the accompanying drawings.

It is obvious that the following exemplary embodiment is a detailed description which is provided for more understanding of the present invention but does not limit the scope of the present invention. Therefore, an equivalent invention which performs the same function as the present invention may be also covered by the scope of the present invention.

In adding reference numerals to components of each drawing, even though the same components are illustrated in different drawings, it is to be noted that these components are denoted by the same reference numerals if possible. In describing exemplary embodiments of the present invention, well-known functions or constructions will not be described in detail since they may unnecessarily obscure the understanding of the present invention.

In addition, in describing components of the present specification, terms such as first, second, A, B, (a), and (b) may be used. These terms are used only to differentiate the components from other components, but the nature, sequence, order, etc. of the corresponding components are not limited by these terms. When a component is “connected”, “coupled”, or “linked” to another component, it is to be noted that the component may be directly connected or linked to the another component, but the component may be “connected”, “coupled”, or “linked” to the another component via another component therebetween.

In an exemplary embodiment of the present invention, “communication”, “communication network” and “network” may be used to have the same meaning. The three terminologies indicate a wired or wireless local area and wide area data transmitting/receiving network through which a file is transmitted/received between a user terminal, another user terminal, and a download server.

In the following description, “game server” indicates a server computer to which users access to use game contents. In the case of a game which has a small capacity or a small number of users, a plurality of game programs may be operated by one game server. Further, in the case of a game which has a large capacity or a large number of real time accessing users, one or more game servers which operate one game may be provided depending on a function of the game.

In addition, middle ware for database or servers which perform payment processing may be connected to the game server, but the description thereof will be omitted in the present invention.

Herein, an online game indicates game contents that can be used by users who access the aforementioned game server. Particularly, the online game indicates a game that can be simultaneously accessed and enjoyed by a plurality of users and increase levels of the users by, e.g., acquiring experience levels while rearing characters through playing of the game on the game.

The auction in an online game is a kind of item buying method. Specifically, an auction-registering user terminal 200 registers auction items in an auction server (not shown), and an auction-bidding user terminal 201 accesses the auction server to search and bid for a necessary auction item to thereby buy the auction item through successfully bidding for it.

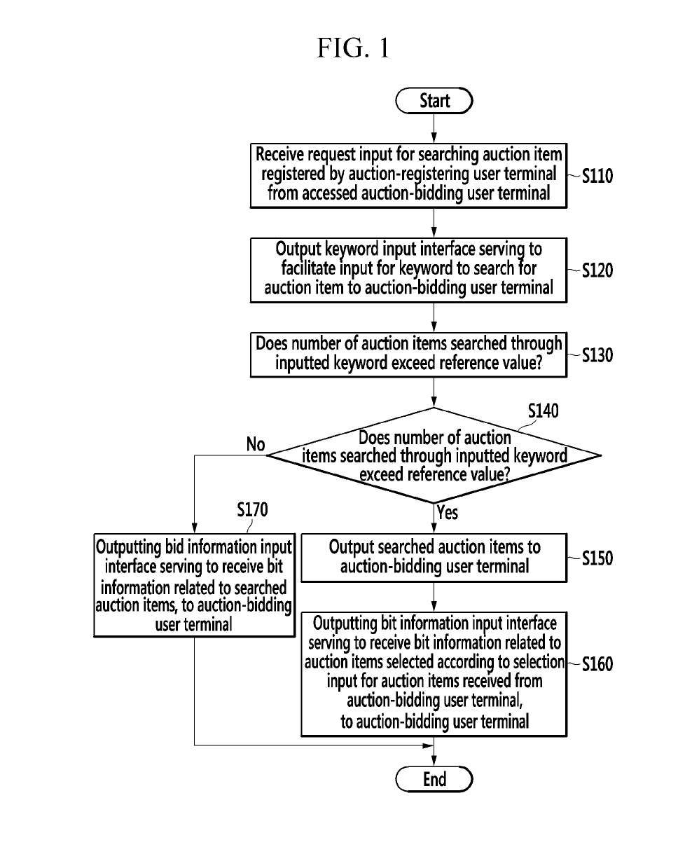

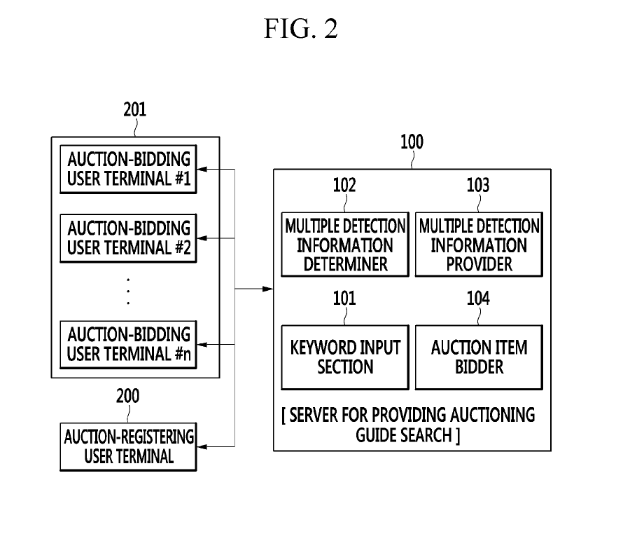

FIG. 1 is a flowchart showing a method for providing an auctioning guide search in accordance with an exemplary embodiment of the present invention, and FIG. 2 is a functional block diagram showing a server for providing an auctioning guide search in accordance with the present exemplary embodiment.

As shown in FIG. 1, the method for providing an auctioning guide search in accordance with the exemplary embodiment of the present invention is performed by a server 100 for providing the auctioning guide search unless otherwise defined.

The auction-registering user terminal 200 and the at least one auction-bidding user terminal 201 are connected to the auctioning guide search providing server 100.

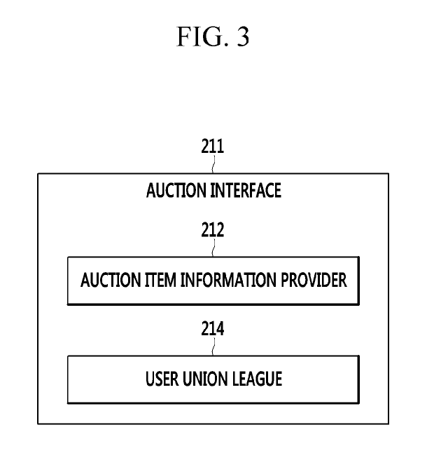

First, when an input selection related to a request for searching an auction item registered by the auction-registering user terminal 200 is received from the accessed auction-bidding user terminal 201 (S110), a keyword input interface through which a keyword can be inputted to search for an auction item is outputted to the auction-bidding user terminal 201 (S120). Then, an auction item information provider 212 for displaying the searched auction item to the user as shown in FIG. 3, and a keyword input interface 213 for inputting an auction item keyword for the search are outputted to the auction-bidding user terminal 201. In this case, the searched auction item does not exist in the auction item information provider 212 yet, and thus the auction item is not displayed.

Thereafter, when a keyword for searching a desired auction item to be searched is inputted/received from the auction-bidding user terminal 201 (S130), whether the number of auction items searched through the inputted keyword exceeds a predetermined reference value is determined (S140). Herein, maximum 5 auction items are considered as the reference value, but the present exemplary embodiment is not thereto.

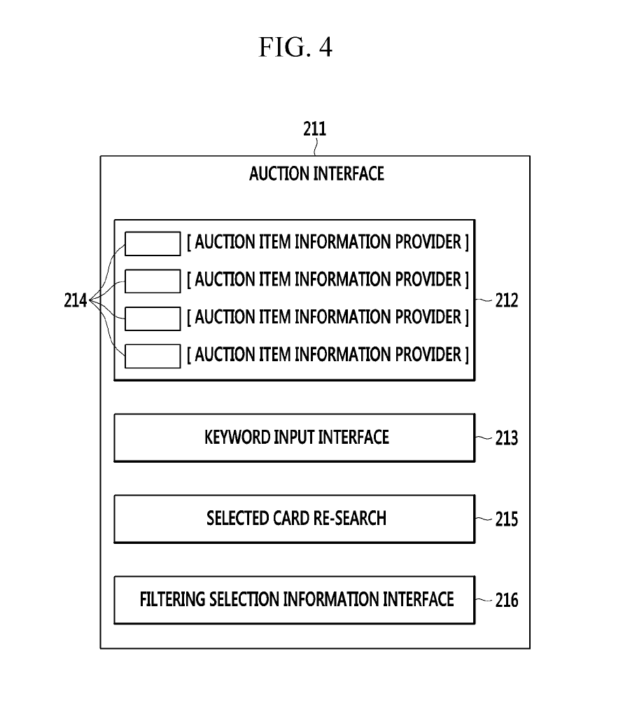

When the number of the searched auction items exceeds the reference level (Yes in step S140), at least one auction item searched to exceed the reference level is outputted to the auction-bidding user terminal 201 so as to enable the user to select a desired auction item from among the excessively searched auction items (S150). Then, as shown in FIG. 4, information 212 of at least one searched auction items, a re-search 215 for a selected card, and an interface 216 for filtering selected information are outputted, and a keyword input interface 213 may be further outputted.

In the step S160, when the number of the searched auction items exceeds the predetermined reference value. It is preferable to output information for reporting that the number of the searched auction items exceeds the reference value to the auction-bidding user terminal 201. For example, when the number of the auction items exceeds 5, information such as “too many items corresponding to inputted keyword are searched, and this screen is moved to search guide” may be outputted in a pop-up form to the auction-bidding user terminal 201.

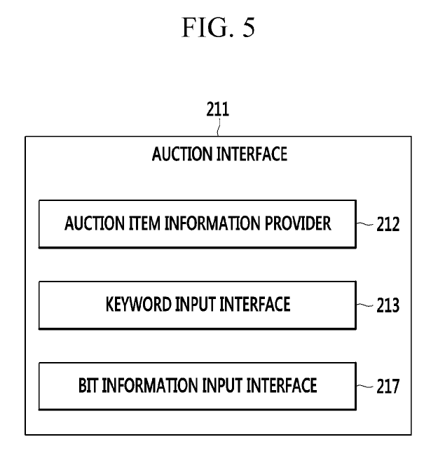

Next, a bit information input interface 217 serving to receive bit information related to auction items selected according to a selection input for the auction items received from the auction-bidding user terminal 201 is outputted to the auction-bidding user terminal 201 (S160). Then, as shown in FIG. 5, the bid information input interface 217 is displayed on the auction-bidding user terminal 201.

In contrast, when the number of the searched auction items does not exceed the reference level (No in step S140), the bid information input interface 217 for receiving bit information related to the searched auction items is outputted to the auction-bidding user terminal 201 (S170).

In the meantime, in the step S160, a check box menu serving to facilitate a selection input for the auction items searched to exceed the reference value by a user is preferably outputted to the auction-bidding user terminal 201. As a result, a user can select desired one from among the excessively searched auction items.

Further, in the step S160, a selected item searching menu serving to re-search for the auction items selected from among the auction items searched to exceed the reference value is preferably outputted to the auction-bidding user terminal 201. Accordingly, when the auction items selected by the user are received from the auction-bidding user terminal 201, the bid information input interface 217 for receiving bid information related to the selected auction items may be outputted to the auction-bidding user terminal 201.

In addition, in the step S160, a filtering selecting menu serving to facilitate an input for filtering the searched auction items per kind is preferably outputted to the auction-bidding user terminal 201. In the present exemplary embodiment, even though the same keyword is provided for the auction items, the auction items having different basic ability values are determined as different items. Accordingly, the filtering selecting menu serving to facilitate filtering of the auction items based on the basic ability values may be outputted to the auction-bidding user terminal 201.

In the meantime, in the step S160, when a selection input of a user terminal related to a selected item search menu serving to facilitate selection from among the searched auction items through a right click of an indicator of the user terminal is received, a result of searching an auction item that is subjected to the right click of the indicator is preferably outputted to the auction-bidding user terminal 201.

FIG. 2 is a functional block diagram showing a server for providing an auctioning guide search in accordance with the present exemplary embodiment.

As shown in FIG. 2, the auction-registering user terminal 200 and at least one auction-bidding user terminal 201 are connected to the auctioning guide search providing server 100 in accordance with the present exemplary embodiment.

With the aforementioned structure, the auctioning guide search providing server 100 includes a keyword input section 101, a multiple detection information determiner 102, a multiple detection information provider 103, and an auction item bidder 104.

When a request input for searching an auction item registered by the accessed auction-registering user terminal 200 is received, the keyword input section 101 outputs a keyword input interface 213 through which a keyword can be inputted to the auction-bidding user terminal 201. Then, an auction item information provider 212 for displaying the searched auction item to the user as shown in FIG. 3, and the keyword input interface 213 for inputting an auction item keyword for the search are outputted to the auction-bidding user terminal 201. In this case, the searched auction item does not exist in the auction item information provider 212 yet, and thus the auction item is not displayed.

When a keyword for searching a desired auction item to be searched is inputted/received auction-bidding user terminal 201, the multiple detection information determiner 102 determines whether the number of auction items searched through the inputted keyword exceeds a predetermined reference value. Herein, maximum 5 auction items are considered as the reference value, but the present exemplary embodiment is not thereto.

When the number of the searched auction items exceeds the reference level, the multiple detection information provider 103 outputs at least one auction item searched to exceed the reference level to the auction-bidding user terminal 201 so as to enable the user to select a desire auction item from among the excessively searched auction items. Then, as shown in FIG. 4, information 212 of at least one searched auction items, a re-search 215 for a selected card, and an interface 216 for filtering selected information are outputted, and a keyword input interface 213 may be further outputted.

The auction item bidder 104 outputs a bit information input interface 217 serving to receive bit information related to auction items selected according to a selection input for the auction items received from the auction-bidding user terminal 201 to the auction-bidding user terminal 201. Then, as shown in FIG. 5, the bid information input interface 217 is displayed on the auction-bidding user terminal 201.

In contrast, if the number of the searched auction items does not exceed the reference level, the auction item bidder 104 preferably outputs the bid information input interface 217 for receiving bit information related to the searched auction items to the auction-bidding user terminal 201.

The multiple detection information provider 103 preferably outputs a check box menu serving to facilitate a selection input for the auction items searched to exceed the reference value by a user to the auction-bidding user terminal 201. As a result, a user can select desired one from among the excessively searched auction items.

In the meantime, the multiple detection information provider 103 preferably outputs a selected item searching menu serving to re-search for the auction items selected from among the auction items searched to exceed the reference value to the auction-bidding user terminal 201.

Further, the multiple detection information provider 103 preferably outputs a filtering selecting menu serving to facilitate input for filtering the searched auction items per kind to the auction-bidding user terminal 201.

When a selection input of a user terminal related to a selected item search menu serving to facilitate selection from among the searched auction items through a right click of an indicator of the user terminal is received, the multiple detection information provider 103 preferably outputs a result of searching an auction item that is subjected to the right click of the indicator to the auction-bidding user terminal 201. Further, when the number of the searched auction items exceeds the predetermined reference value, the multiple detection information provider 103 preferably outputs information for reporting that the number of the searched auction items exceeds the reference value to the auction-bidding user terminal 201. For example, when the number of the auction items exceeds 5, information such as “too many items corresponding to inputted keyword are searched, and this screen is moved to search guide” may be outputted in a pop-up form to the auction-bidding user terminal 201.

The method for providing an auctioning guide search in accordance with the exemplary embodiments of the present invention as described above may be executed by the applications basically installed in the terminal (including programs included in a platform, an operating system, or the like which are basically installed in the terminal), and may also be executed by the applications (i.e., programs) which are directly installed in the terminal by the user via an application store server or an application store server such as a web server associated with the applications or the corresponding services. In this respect, the method for providing an auctioning guide search in accordance with the exemplary embodiment of the present invention may be implemented by the applications (i.e., programs) which are basically installed or directly installed by the user in the terminal and may be recorded in a computer readable recording medium of the terminal, and the like.

The programs are recorded in the computer readable recording medium and are executed by the computer, such that the above-mentioned functions may be executed.

As described above, in order for the computer to read the programs recorded in the recording medium and execute the method for providing an auctioning guide search in accordance with the exemplary embodiment of the present invention, the above-mentioned programs may include codes which are coded with computer languages such as C, C++, JAVA, machine language, and the like which may be read by a processor (CPU) of the computer. The code may include a function code associated with a function of defining the above-mentioned functions and may also include an execution procedure related control code required for the processor of the computer to execute the above-mentioned functions according to a predetermined procedure.

Further, in order for the processor of the computer to execute the above-mentioned functions, when the processor needs to communicate with any other computers or servers, etc. at a remote location, the code may further include a communication related code about how the processor of the computer communicates with any other computers or servers at a remote location or which information or media the processor of the computer transmits and receives at the time of the communication, by using the communication module (for example, wired and/or wireless communication module) of the computer.

Further, in order for the processor of the computer to execute the above-mentioned functions, when the processor needs to communicate with any other computers or servers, etc. at a remote location, the code may further include a communication related code about how the processor of the computer communicates with any other computers or servers at a remote location or which information or media the processor of the computer transmits and receives at the time of the communication, by using the communication module (for example, wired and/or wireless communication module) of the computer.

Further, a functional program for implementing the present invention, a code and a code segment associated therewith, and the like may be easily inferred or changed by programmers in the art to which the present invention pertains in consideration of a system environment of the computer which reads the recording medium and executes the program.

Hereinabove, examples of a computer readable recording medium recorded with programs as described above include a ROM, a RAM, a CD-ROM, a magnetic tape, a floppy disk, an optical media storage device, and the like.

Further, a computer readable recording medium recorded with programs as described above may be distributed to a computer system connected through a network and thus store and execute a computer readable code by a distributed manner. In this case, at least one computer among a plurality of distributed computers may execute a part of the above-mentioned functions and transmit the executed results to at least one of the other distributed computers, and the computer receiving the result may also execute a part of the above-mentioned functions and provide the executed results to the other distributed computers.

In particular, a computer readable recording medium recorded with applications, which are programs for executing the method for providing an auctioning guide search in accordance with the exemplary embodiment of the present invention, may be a storage medium (for example, hard disk, and the like) included in an application store server or an application providing server such as a web server associated with applications or corresponding services, and the like, or the application providing server itself.

A computer, which may read a recording medium recorded with applications that are programs for executing the method for providing an auctioning guide search in accordance with the exemplary embodiment of the present invention, may include not only a general PC such as a typical desktop and a laptop but also a mobile terminal such as a smart phone, a tablet PC, personal digital assistants (PDAs), and a mobile communication terminal, and is to be construed as all the computable devices.

When a computer, which may read a recording medium recorded with applications that are programs for executing the method for providing an auctioning guide search in accordance with the exemplary embodiment of the present invention, is a mobile terminal such as a smart phone, a tablet PC, a personal digital assistant (PDA), and a mobile communication terminal, the applications are downloaded from an application providing server to a general PC and thus may also be installed in the mobile terminal through a synchronization program.

Hereinabove, although it has been mentioned that all components configuring the exemplary embodiment of the present invention described hereinabove are combined with each other as one component or are combined and operated with each other as one component, the present invention is not necessarily limited to the above-mentioned exemplary embodiment. That is, all the components may also be selectively combined and operated with each other as one or more component without departing from the scope of the present invention. In addition, although each of all the components may be implemented by one independent hardware, some or all of the respective components which are selectively combined with each other may be implemented by a computer program having a program module performing some or all of functions combined with each other in one or plural hardware. The codes and the code segments configuring the computer program may be easily inferred by a person having ordinary skill in the art to which the present invention pertains. The computer programs are stored in the computer readable media and are read and executed by the computer and may implement the exemplary embodiment of the present invention. As the storage medium of the computer programs, a magnetic recording medium, an optical recording medium, and the like may be used.

Further, it will be further understood that the terms “comprises” or “have” used in this specification may include the corresponding components unless explicitly described to the contrary and therefore, do not preclude other components but further include the components. In addition, unless defined otherwise in the detailed description, all the terms including technical and scientific terms have the same meaning as meanings generally understood by those skilled in the art to which the present invention pertains. Generally used terms such as terms defined in a dictionary should be interpreted as the same meanings as meanings within a context of the related art and should not be interpreted as ideally or excessively formal meanings unless clearly defined in the present specification.

The spirit of the present invention has been just exemplified. It will be appreciated by those skilled in the art that various modifications and alterations can be made without departing from the essential characteristics of the present invention. Accordingly, the exemplary embodiments disclosed in the present invention do not limit but describe the spirit of the present invention, and the scope of the present invention is not limited by the exemplary embodiments. The scope of the present invention should be interpreted by the following claims and it should be interpreted that all spirits equivalent to the following claims fall within the scope of the present invention.

1. A method for providing an auctioning guide search, the method comprising:
by a server for providing the auctioning guide search,
receiving a request input for searching an auction item registered by an auction-registering user terminal from an accessed auction-bidding user terminal and outputting a keyword input interface to the auction-bidding user terminal, the keyword input interface serving to facilitate an input for a keyword to search for the auction item;
receiving an input of a keyword for searching a desired auction item to be searched from the auction-bidding user terminal and determining whether the number of auction items searched through the inputted keyword exceeds a predetermined reference value;
outputting at least one auction item searched to exceed the reference level to the auction-bidding user terminal to enable a user to select a desired auction item from among the excessively searched auction items, when the number of the searched auction items exceeds the reference level; and
outputting a bit information input interface to the auction-bidding user terminal, the bit information input interface serving to receive bit information related to auction items selected according to a selection input for the auction items received from the auction-bidding user terminal.

2. The method of claim 1, wherein the outputting of at least one auction item searched to exceed the reference level to the auction-bidding user terminal includes outputting a filtering selecting menu to the auction-bidding user terminal, the filtering selecting menu serving to facilitate an input for filtering the searched auction items per kind.

3. The method of claim 1, wherein the outputting of at least one auction item searched to exceed the reference level to the auction-bidding user terminal includes outputting a selected item searching menu to the auction-bidding user terminal, the selected item searching menu serving to re-search for the auction items selected from among the auction items searched to exceed the reference value.

4. The method of claim 1, wherein the outputting of at least one auction item searched to exceed the reference level to the auction-bidding user terminal includes outputting a check box menu to the auction-bidding user terminal, the check box menu serving to facilitate a selection input for the auction items searched to exceed the reference value by a user.

5. The method of claim 1, further comprising
outputting a bid information input interface to the auction-bidding user terminal, the bid information input interface serving to receive bit information related to the searched auction items, when the number of the searched auction items does not exceed the reference level.

6. The method of claim 1, wherein the outputting of at least one auction item searched to exceed the reference level to the auction-bidding user terminal includes, when a selection input of a user terminal related to a selected item search menu serving to facilitate selection from among the searched auction items through a right click of an indicator of the user terminal is received, outputting a result of searching an auction item that is subjected to the right click of the indicator to the auction-bidding user terminal.

7. The method of claim 1, wherein the outputting of at least one auction item searched to exceed the reference level to the auction-bidding user terminal includes, when the number of the searched auction items exceeds the predetermined reference value, outputting information for reporting that the number of the searched auction items exceeds the reference value to the auction-bidding user terminal.

8. A server for providing an auctioning guide search, the server comprising:
a keyword input section configured to receive a request input for searching an auction item registered by an auction-registering user terminal from an accessed auction-bidding user terminal and output a keyword input interface to the auction-bidding user terminal, the keyword input interface serving to facilitate an input for a keyword to search for the auction item;
a multiple detection information determiner configured to receive an input of a keyword for searching a desired auction item to be searched from the auction-bidding user terminal and determine whether the number of auction items searched through the inputted keyword exceeds a predetermined reference value;
a multiple detection information provider configured to output at least one auction item searched to exceed the reference level to the auction-bidding user terminal to enable a user to select a desired auction item from among the excessively searched auction items, when the number of the searched auction items exceeds the reference level; and
an auction item bidder configured to output a bit information input interface to the auction-bidding user terminal, the bit information input interface serving to receive bit information related to auction items selected according to a selection input for the auction items received from the auction-bidding user terminal.

9. The server of claim 8, wherein the multiple detection information provider outputs a filtering selecting menu to the auction-bidding user terminal, the filtering selecting menu serving to facilitate an input for filtering the searched auction items per kind.

10. The server of claim 8, wherein the multiple detection information provider outputs a selected item searching menu to the auction-bidding user terminal, the selected item searching menu serving to re-search for the auction items selected from among the auction items searched to exceed the reference value.

11. The server of claim 8, wherein the multiple detection information provider outputs a check box menu to the auction-bidding user terminal, the check box menu serving to facilitate a selection input for the auction items searched to exceed the reference value by a user.

12. The server of claim 8, wherein, when the number of the searched auction items does not exceed the reference level,
the auction item bidder outputs a bid information input interface to the auction-bidding user terminal, the bid information input interface serving to receive bit information related to the searched auction items.

13. The server of claim 8, wherein, when a selection input of a user terminal related to a selected item search menu serving to facilitate selection from among the searched auction items through a right click of an indicator of the user terminal is received, the multiple detection information provider outputs a result of searching an auction item that is subjected to the right click of the indicator to the auction-bidding user terminal.

14. The server of claim 8, wherein, when the number of the searched auction items exceeds the predetermined reference value,
the multiple detection information provider outputs information for reporting that the number of the searched auction items exceeds the reference value to the auction-bidding user terminal.

15. A computer readable recording medium recorded with program for executing a method for providing an auctioning guide search,
wherein the method includes:
by a server for providing the auctioning guide search,
receiving a request input for searching an auction item registered by an auction-registering user terminal from an accessed auction-bidding user terminal and outputting a keyword input interface to the auction-bidding user terminal, the keyword input interface serving to facilitate an input for a keyword to search for the auction item;
receiving an input of a keyword for searching a desired auction item to be searched from the auction-bidding user terminal and determining whether the number of auction items searched through the inputted keyword exceeds a predetermined reference value;
outputting at least one auction item searched to exceed the reference level to the auction-bidding user terminal to enable a user to select a desired auction item from among the excessively searched auction items, when the number of the searched auction items exceeds the reference level; and
outputting a bit information input interface to the auction-bidding user terminal, the bit information input interface serving to receive bit information related to auction items selected according to a selection input for the auction items received from the auction-bidding user terminal.

16. The method of claim 4, wherein the outputting of at least one auction item searched to exceed the reference level to the auction-bidding user terminal includes, when a selection input of a user terminal related to a selected item search menu serving to facilitate selection from among the searched auction items through a right click of an indicator of the user terminal is received, outputting a result of searching an auction item that is subjected to the right click of the indicator to the auction-bidding user terminal.
